(19) United States
(12) Patent Application Publication
(10) Pub. No.: US 2025/0190331 A1
(43) Pub. Date: Jun. 12, 2025

(54) SOFTWARE APPLICATION BUILD TESTING WITH ADAPTIVE TEST CASE SELECTION

(71) Applicant: SAP SE, Walldorf (DE)

(72) Inventors: Jingun Hong, Seoul (KR); Dong Won Hwang, Seoul (KR); Gabin An, Daejeon (KR)

(21) Appl. No.: 18/535,208

(22) Filed: Dec. 11, 2023

(51) Int. Cl. G06F 11/36

(52) U.S. Cl. CPC G06F 11/368; G06F 11/3688

(57) ABSTRACT

Various examples are directed to systems and methods for maintaining a software application. A testing system may execute a test selection computerized model, where an output of the test selection computerized model is based at least in part on the commit operation and a plurality of test cases. The testing system may also execute a defect prediction computerized model, where an output of the defect prediction computerized model is based at least in part on the commit operation. The testing system may generate a ranked set of test cases selected from the plurality of test cases, the ranked set of test cases comprising less than all of the plurality of test cases and execute at least a portion of the ranked set of test cases against the build of the software application.

### BACKGROUND

Traditionally modes of software development involve developing a software application and then performing error detection and debugging on the application before it is released to customers and/or other users. Error detection and debugging were time-consuming, largely manual activities. Because releases were typically separated in time by several months or even years, however, smart project planning could leave sufficient time and resources for adequate error detection and debugging.

### BRIEF DESCRIPTION OF DRAWINGS

The present disclosure is illustrated by way of example and not limitation in the following figures.

FIG. 1 is a diagram showing one example of an environment for software testing.

FIG. 2 is a diagram showing one example of a continuous integration/continuous delivery (CI/CD) pipeline incorporating various software testing described herein.

FIG. 3 is a flowchart showing one example of a process flow that may be executed in the environment of FIG. 1 to implement the testing system.

FIG. 4 is a flowchart showing one example of a process flow that may be executed in the environment of FIG. 1 to test a new build.

FIG. 5 is a block diagram showing one example of a software architecture for a computing device.

FIG. 6 is a block diagram of a machine in the example form of a computer system within which instructions may be executed for causing the machine to perform any one or more of the methodologies discussed herein.

### DETAILED DESCRIPTION

Various examples described herein are directed to software testing and error detection that may be performed in an automated manner.

In many software delivery environments, modifications to a software application are coded, tested, and sometimes released to users on a fast-paced timescale, sometimes quarterly, bi-weekly, or even daily. Also, large-scale software applications may be serviced by a large number of software developers, with many developers and developer teams making modifications to the software application.

In some example arrangements, a continuous integration/continuous delivery (CI/CD) pipeline arrangement is used to support a software application. According to CI/CD pipeline, a developer entity maintains an integrated source of an application, called a mainline or mainline build. The mainline build is the most recent build of the software application. At release time, the mainline build is released to and may be installed at various production environments such as, for example, at public cloud environments, private cloud environments, and/or on-premise computing systems where users can access and utilize the software application.

Between releases, a development team or teams may work to update and maintain the software application. When it is desirable for a developer to make a change to the application, the developer checks out a version of the mainline build from a source code management (SCM) system into a local developer repository. The developer builds and tests modifications to the mainline. When the modifications are completed and tested, the developer initiates a commit operation. In the commit operation, the CI/CD pipeline executes an additional series of integration and acceptance tests to generate a new mainline build that includes the developer's modifications.

As software applications become larger and more complicated, the number and frequency of commit operations increases. The amount of time and computing resources used to execute test cases may also increase. As a result, it may become impractical to execute all test cases for each build of the mainline. One way to address this challenge is to execute more complex test cases on less than all of the mainline builds. For example, certain test cases may be executed periodically (e.g., every 12 hours, every 24 hours, every business day, every 48 hours, every week, etc.). In other examples, some test cases are executed after a predetermined number of commits (e.g., every 10 commit operations, every 50 commit operations, etc.). When test cases are executed on less than all of the builds of a software application, however, additional challenges may be created. For example, if a test case fails due to a bug or error in a current mainline build, determining which commit operation induced the error may be non-trivial.

Various examples described herein address these and other challenges using adaptive test case selection. A testing system may be configured to execute trained computerized models that include, for example, a test selection computerized model and a defect prediction computerized model. The test selection computerized model may receive input describing a commit operation and/or corresponding build of the mainline and test case data describing a plurality of test cases. An output of the test selection computerized model may provide an indication of a preliminary ranked set of test cases from the plurality of test cases that have the most potential relevance to the commit operation and/or the corresponding build.

The defect prediction computerized model may receive input describing the commit operation and/or the corresponding build of the mainline and may generate an output indicating a likelihood of errors in the build. The testing system may utilize the output of the test selection computerized model and the defect prediction computerized model to generate a ranked set of test cases. The ranked set of test cases may include less than all of the plurality of considered test cases. The ranked set of test cases may also be ranked in an order indicating a likelihood that the build will fail each of the respective test cases. For example, the first of the ranked set of test cases may be a test case that the build is most likely to fail. The second of the ranked list of test cases may be a test case that the build is next most likely to fail, and so on.

The testing system may apply the ranked set of test cases to the build in order of the ranking. If the build fails a test case, the testing may conclude, and the testing system may execute a corrective action.

Ranking the test cases in an order indicating the likelihood that the build will fail each respective test case may reduce resource usage at the testing system for builds that fail at least one test case. For example, ranking the test cases may decrease the number of test cases that are executed before the build fails a test case. Generating a ranked set of test cases that includes less than all of the plurality of test cases may also reduce resource usage at the testing system by reducing the number of test cases executed for non-erroneous builds without sacrificing robustness.

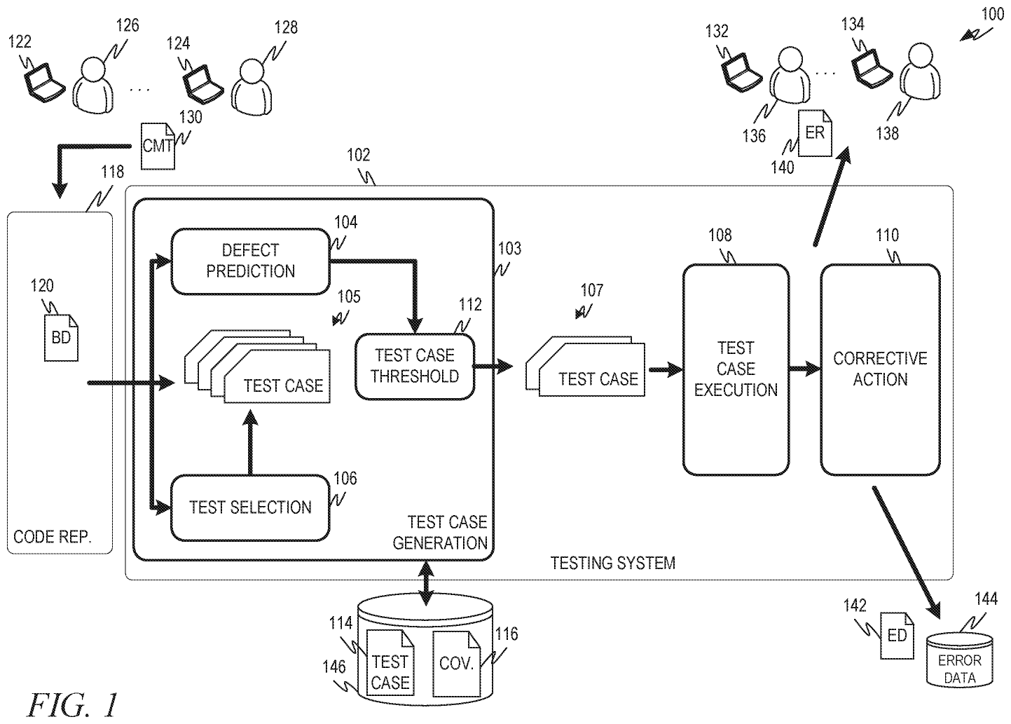

FIG. 1 is a diagram showing one example of an environment 100 for software testing. The environment 100 comprises a testing system 102 and a code repository 118, which may be all or part of an SCM system. The testing system 102 may include one or more computing devices that may be located at a single geographic location and/or distributed across different geographic locations.

One or more developer users 126, 128 may generate commit operations, such as commit operation 130. Developer users 126, 128 may utilize user computing devices 122, 124. User computing devices 122, 124 may be or include any suitable computing device such as, for example, desktop computers, laptop computers, tablet computers, mobile computing devices, and/or the like. For example, one or more of the developer users 126, 128 may check out a mainline of a software application from a code repository 118, which may be part of an SCM. The commit operation 130 may include changes to the previous mainline build. The commit operation 130 may result in a new build 120. The testing system 102 may perform integration and acceptance tests on the changes implemented by the new build 120.

The testing system 102 comprises a test case generation subsystem 103, a test case execution subsystem 108, a corrective action subsystem 110, and a test case threshold subsystem 112. The test case generation subsystem 103 is programmed to execute computerized models 104, 106, as described herein. The various subsystems 103, 108, 110, 112 may be implemented using various hardware and/or software subcomponents of the testing system 102. In some examples, one or more of the subsystems 108, 110, 112 and/or computerized models 104, 106 is implemented on a discrete computing device or set of computing devices.

The testing system 102 is configured to test the new build 120 by applying one or more test cases. A test case may comprise input data describing a set of input parameters provided to a build and result data describing how the build is expected to behave when provided with the set of input parameters. The test case execution subsystem 108 may apply a test case to a build by executing the build, applying the test parameters to the build, and observing the response of the build. A build may pass the test case if it responds to the input data in the way described by the result data. If a build fails to respond to the input data in the way described by the result data, the build may fail the test case.

Consider an example in which a build is or includes a database management application. Test case data may comprise a set of one or more queries to be executed by the database management application and result data describing how the database management application should behave in response to the queries. The build may pass the test case if it generates the expected result data in response to the provided queries. Conversely, the build may fail the test case if it generates result data that deviates from the expected result data.

The test case generation subsystem 103 may be programmed to generate a ranked set of test cases 107 that are executed on the new build 120 by the test case subsystem 108. The test case generation subsystem 103 may access the new build 120 and, in some examples, the commit operation 130. The test case generation subsystem 103 may also access test case data 114 from a data store 146. The test case data 114 describes a plurality of test cases that are for testing builds of the software application.

The plurality of test cases described by the test case data 114, in some examples, includes test cases that are developed to test all aspects and components of the software application. It will be appreciated, however, that not all commit operations make changes that affect all aspects and components of the software application. Instead, it may be more common for a commit operation, such as the commit operation 130, to make changes to less than all of the aspects and components of the software application. As a result, the plurality of test cases described by the test case data may be overinclusive.

The test case generation subsystem 103 may generate the ranked set of test cases 107 to include test cases that are most relevant to the new build 120 while omitting test cases from the plurality of test cases that are less relevant to the new build 120. For example, the test case generation subsystem 103 may execute trained computerized models including, for example, a test selection computerized model 106 and a defect prediction computerized model 104. The test selection computerized model 106 may receive input describing the new build 120, the commit operation 130, and the test case data 114. An output of the test selection computerized model 106 may provide a preliminary ranked set of test cases 105. In some examples, the output of the test selection computerized model 106 is applied to the test case data to generate the preliminary ranked set of test cases 105.

The test selection computerized model 106 may be of any suitable computerized model form. For example, the test selection computerized model 106 may be a logistic regression model, a decision tree model, a random forest model, a support vector machine model, a K-nearest neighbors model, a gradient boosting model, an Adaptive Boosting (AdaBoost) model, a neural network model, an extreme Gradient Boosting (XGBoost) model, and/or the like.

The test selection computerized model 106 may be trained to rank candidate test cases from the plurality of test cases described by the test case data 114 based on the likelihood that the test cases will identify a defect in the new build 120. For example, the test selection computerized model 106 may receive input parameters describing the commit operation 130 and/or the new build 120.

The test selection computerized model 106 may also receive input parameters describing the plurality of test cases. These may include, for example, historical features of the test cases, lexical features of the test cases, and/or dynamic features of the test cases. Historical features of a test case may describe past executions of the test case. Examples of historical features of a test case may include a past failure rate, a transition rate, an age of the test case, a last transition age, a last fail age, and an execution time. The past failure rate of a test case describes the rate at which builds fail the test case. A transition for a test case may occur when the outcome of the test case changes between consecutively-considered builds. For example, a transition for a test case may occur when one build fails a test case and the next-considered build passes the test case or when one build passes a test case and the next-considered build fails the test case. The transition rate of a test case may indicate the rate of transitions.

The age of a test case may indicate, for example, how long a test case has been used, a number of times the test case has been executed, and/or the like. The last transition age of a test case may indicate a time or number of executions of the test case since the test case last resulted in a transition. The last fail age of a test case may indicate a time or number of executions of the test case since the test case resulted in the failure of a build. Execution time may indicate how long it takes to execute a test case. In some examples, execution time may be aggregated over multiple executions of the test case, for example, using an average execution time, a median execution time, and/or the like.

Lexical features of a test case describe properties of the test case that may relate to the new build 120 and/or the commit operation 130 that resulted in the new build. For example, lexical features of a test case may provide an indication of how relevant the test case is to the current code change represented by the new build 120. In some examples, a lexical feature may include a name or title of the test case. The test selection computerized model 106 may be trained to liken the title of the test case to the titles of one or more filenames of the new build 120 that are modified by the commit operation 130.

Dynamic features of a test case describe interaction between a test case and a build. Dynamic features of a test case may include, for example, coverage data 116. Coverage data 116 for a test case may describe portions of the software application that are tested by the test case. For example, coverage data 116 may be used to generate a coverage score describing the degree to which a test case covers portions of the new build 120 that were modified by the commit operation 130. This may include, for example, a number of code elements (e.g., lines, files, and/or the like) that are modified by the commit operation and also tested by the test case. In some examples, the precise coverage of a test case relative to the new build 120 may be obtained after actual execution of the test case. Accordingly, the coverage for a test case relative to the new build may be estimated against a previous version of the software application.

An output of the test selection computerized model 106, in some examples, includes a ranking or score of the plurality of test cases described by the test case data 114. This may result in the preliminary ranked set of test cases 105. In some examples, the output of the test selection computerized model 106 provides a ranking of all test cases in the plurality of test cases described by the test case data 114. In other examples, the output of the test selection computerized model 106 includes less than all of the test cases described by the test case data 114.

The test case ranking generated by the test selection computerized model 106 may indicate a relevance of the respective test cases to the new build 120. For example, the relevance of a test case to the new build 120 may indicate how likely the respective test cases are to reveal a potential fault in the new build 120.

The defect prediction computerized model 104 may receive input describing the new build 120 and/or commit operation 130. An output of the defect prediction computerized model 104 may describe a likelihood that the commit operation 130 and/or the resulting new build 120 has introduced a software defect to the software application. The output of the defect prediction computerized model may be used by a test case threshold subsystem 112 to winnow the preliminary ranked set of test cases 105 and generate the ranked set of test cases 107 that is provided to the test case execution subsystem 108, where the ranked set of test cases 107 may be a subset of the preliminary ranked set of test cases 105.

The defect prediction computerized model 104 may receive inputs describing the new build 120 and the commit operation 130 indicating the changes to the new build 120 relative to a prior build. For example, the defect prediction computerized model 104 may be a logistic regression model, a decision tree model, a random forest model, a support vector machine model, a K-nearest neighbors model, a gradient boosting model, an Adaptive Boosting (AdaBoost) model, a neural network model, an extreme Gradient Boosting (XGBoost) model, and/or the like.

Example input parameters that may be provided to the defect prediction computerized model 104 include diffusion input parameters, purpose input parameters, size input parameters, history input parameters, developer experience input parameters, code churn input parameters, change context input parameters, indentation input parameters, file-level process metrics, commit message features, human-generated data, and static analysis data.

Diffusion input parameters describe the diffusion of a build or commit operation, such as a distribution of changes by a commit operation to a build. For example, diffusion data may indicate how spread out the changes are relative to a previous build. For example, diffusion input parameters may be measured based on different metrics such as, the number or portion of lines of code modified, a number or portion of files modified, and/or the like. History input parameters may describe previous changes made to the software application, for example, by previous commit operations.

Purpose input parameters may describe a purpose or reason why the change implemented by the commit operation 130 was made. Purpose input parameters may be determined, for example, from a commit operation and/or from notes provided with the commit operation 130 by the developer user 126, 128. Size input parameters may indicate a size of the change to the build such as, for example, measured in lines, files, bytes, and/or the like. Experience input parameters may describe a level of experience of the developer user 126, 128 who submitted and/or worked on the commit operation. Experience may be measured, for example, by accessing a human resources database to determine a number of years of experience for the developer user 126, 128. In some examples, experience may be measured based on the current software application. For example, a developer user who has submitted a higher number of commit operations may have a higher experience level.

Code churn input parameters may describe a frequency with which particular files or other subcomponents of the software application are changed, for example, by commit operations such as the commit operation 130. For example, a file or other subcomponents of the software application that is changed frequently may be more likely to include errors than files or other subcomponents of the software application that are modified less often.

Change context input parameters may describe how changes introduced by the commit operation 130 interact with and/or affect surrounding code in the software application. For example, change context input parameters may describe dependencies between modified code portions and surrounding code, an impact of modified code on existing modules or other subunits of the software application, and/or how modified code integrates with the software application as a whole.

Indentation input parameters indicate the number of indentations in lines of code that are new or changed by the commit operation 130. For example, indentations in the code may indicate if/and then statements or other more complex coating structures. File-level process metrics describe the file level changes made in the new build 120 by the commit operation 130. Commit message input parameters include features that describe a commit message accompanying the commit operation 130. This may include, for example, a description of the change provided by the developer user 126, 128. Human generated input parameters may include descriptions of the commit operation generated by human users such as, for example, in code reviews, issue reports, change requests, chat application discussions, and/or the like. Static analysis input parameters may include warning messages, for example, generated during static program analysis of the commit operation 130 and/or the new build 120 (e.g., analysis that does not include executing the new build 120).

The output of the defect prediction computerized model 104 may include a score or other indicator of a likelihood or risk that the new build 120 includes a defect. The test case threshold subsystem 112 receives the preliminary ranked set of test cases 105 and the output of the defect prediction computerized model 104. The test case threshold subsystem 112 may utilize the output of the defect prediction computerized model 104 to winnow or threshold the preliminary ranked set of test cases 105 and generate the ranked set of test cases 107. For example, the test case threshold subsystem 112 may eliminate from the preliminary ranked set of test cases 105 any test cases that have a ranking above a threshold value, where the threshold value is determined based on the output of the defect prediction computerized model 104. In some examples, the preliminary ranked set of test cases 105 also includes relevance scores for each test case. In these examples, the test case threshold subsystem 112 may determine a minimum relevance based on the output of the defect prediction computerized model. The test case threshold subsystem 112 may eliminate test cases having a relevant score less than a threshold from the preliminary ranked set of test cases 105.

The test case execution subsystem 108 may be configured to execute the ranked set of test cases 107 on the new build 120 until the new build 120 either fails a test case or passes all test cases of the ranked set of test cases 107. If the new build 120 passes all test cases, then it may be deployed as a new mainline build. If the new build 120 fails a test case, the testing system 102 may utilize the corrective action subsystem 110 to take one or more corrective actions.

For example, the corrective action subsystem 110 may execute one or more corrective actions based on the new build 120 and/or the commit operation 130 from which it originated. In some examples, the correction action subsystem 110 sends a report message 140 to one or more developer users 132, 134. The report message 140 may comprise an indication of the commit operation 130 and/or the new build 120. In some examples, the corrective action subsystem 110 routes a report message 140 to the developer user 126, 128 that submitted the error-inducing commit operation or to a different developer user 132, 134. The developer users 132, 134 may receive the report message 140 using one or more user computing devices 136, 138, which may be similar to user computing devices 122, 124 described herein.

In some examples, the corrective action subsystem 110 stores error data 142 at an error data store 144. The error data 142 describes the commit operation 130 and/or new build 120 that failed at least one test case. In some examples, the error data 142 also describes one or more report messages 140 provided to one or more developer users 126, 128, 132, 134 for correcting the commit operation 130.

Another example corrective action that may be taken by the corrective action subsystem 110 includes reverting the software application to a good build. A good build may be a build that was generated by a commit operation prior to the commit operation 130. In some examples, the good build is the build generated by the commit operation immediately before the error-inducing commit operation 130.

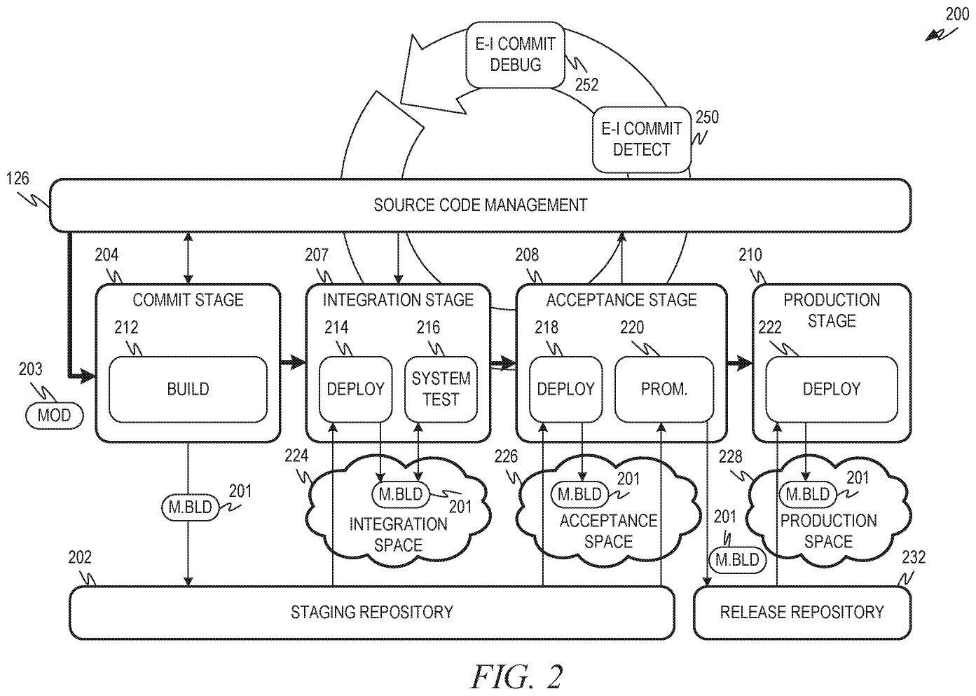

FIG. 2 is a diagram showing one example of a CI/CD pipeline 200 incorporating various software testing described herein. The CI/CD pipeline 200 is initiated when a developer user, such as one of developer users 132, 134, submits a build modification 203 to the commit stage 204, initiating a commit operation. The build modification 203 may include a modified version of the mainline build previously downloaded by the developer user 126, 128.

The commit stage 204 executes a commit operation 212 to create and/or refine the modified software application build 201. For example, the mainline may have changed since the time that the developer user 132, 134 downloaded the mainline version used to create the build modification 203. The modified software application build 201 generated by commit operation 212 includes the changes implemented by the modification 203 as well as any intervening changes to the mainline. The commit operation 212 and/or commit stage 204 stores the modified software application build 201 to a staging repository 202 where it can be accessed by various other stages of the CI/CD pipeline 200.

An integration stage 207 receives the modified software application build 201 for further testing. A deploy function 214 of the integration stage 207 deploys the modified software application build 201 to an integration space 224. The integration space 224 is a test environment to which the modified software application build 201 can be deployed for testing. While the modified software application build 201 is deployed at the integration space 224, a system test function 216 performs one or more integration tests on the modified software application build 201. In some examples, the testing system 102 of FIG. 1 may be utilized to perform all or part of the system test function 216. If the modified software application build 201 fails one or more of the test cases, it may be returned to the developer user 132, 134 for correction. If the modified software application build 201 passes testing, the integration stage 207 provides an indication indicating the passed testing to an acceptance stage 208.

The acceptance stage 208 uses a deploy function 218 to deploy the modified software application build 201 to an acceptance space 226. The acceptance space 226 is a test environment to which the modified software application build 201 can be deployed for testing. While the modified software application build 201 is deployed at the acceptance space 226, a promotion function 220 applies one or more promotion tests to determine whether the modified software application build 201 is suitable for deployment to a production environment. Example acceptance tests that may be applied by the promotion function 220 include Newman tests, UiVeri5 tests, Gauge BDD tests, various security tests, etc. If the modified software application build 201 fails the testing, it may be returned to the developer user 132, 134 for correction. If the modified software application build 201 passes the testing, the promotion function 220 may write the modified software application build 201 to a release repository 232, from which it may be deployed to production environments.

The example of FIG. 2 shows a single production stage 210. The production stage 210 includes a deploy function 222 that reads the modified software application build 201 from the release repository 232 and deploys the modified software application build 201 to a production space 228. The production space 228 may be any suitable production space or environment as described herein.

The various examples for software testing described herein may be implemented during the acceptance stage 208 and/or the integration stage 207. An error-inducing detection operation 250 may be executed by the testing system 102 utilizing fault localization, as described herein. An error-inducing commit debug or correction operation 252 may be executed by the testing system 102 (e.g., the corrective action subsystem 110) as described herein.

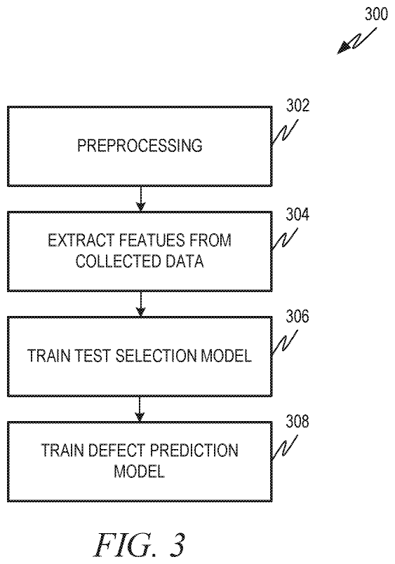

FIG. 3 is a flowchart showing one example of a process flow 300 that may be executed in the environment 100 to implement the testing system 102. In some examples, the process flow 300 may be executed by the test case generation subsystem 103. At operation 302, the test case generation subsystem 103 may perform pre-processing. This may include accessing historical data describing the commit operations, new builds, and the execution of test cases described by the test case data 114. For example, the test case generation subsystem 103 may access change logs for the software application, test case details describing test cases previously applied to the software application, data describing developer users 126, 128, and/or the like.

At operation 304, the test case generation subsystem may extract features from data collected at operation 302. This may include generating labeled training data. Labeled training data may comprise a set of model inputs, where the set of model inputs is labeled to indicate a correct model output to result from the set of model inputs. In some examples, different training data may be created for the defect prediction computerized model 104 and the test selection computerized model 106. For example, labeled training data for the defect prediction computerized model 104 may include various sets of input parameters for the defect prediction computerized model 104 and labels indicating whether the historical build described by the input parameters failed at least one test case. Labeled training data for the test selection computerized model 106 may include a set of input parameters and an indication of which test case or test cases were failed by the historical build and plurality of test cases described by the input parameters.

At operation 306, the test case generation subsystem 103 may train the test selection computerized model 106. For example, the test case generation subsystem 103 may execute a number of training epochs. For each training epoch, the test case generation subsystem 103 may provide the test selection computerized model 106 with input data describing a build and the plurality of test cases. The test selection computerized model 106 may provide an output including a ranked set of test cases from the plurality of test cases. The test case generation subsystem 103 may then compare the ranked set of test cases to labels associated with the input data provided to the test selection computerized model 106. As described herein, the input data may include an indication of whether the described build passed or failed the respective test cases. Based on the label data, the test case generation subsystem 103 may determine an error for the test selection computerized model 106 in the epoch. The test case generation subsystem 103 may utilize any suitable training technique to modify the test selection computerized model 106 based on the error. An example training technique that may be used is gradient descent.

At operation 308, the test case generation subsystem 103 may train the defect prediction computerized model 104. For example, the test case generation subsystem 103 may execute a number of training epochs. For each training epoch, the test case generation subsystem 103 may provide the defect prediction computerized model 104 with input data describing a build and/or a commit operation that resulted in the build. The defect prediction computerized model 104 may provide an output indicating a likelihood that the build will fail at least one test case. The test case generation subsystem 103 may compare the output of the defect prediction computerized model to label data associated with the input provided to the defect prediction computerized model 104. For example, the label data may indicate whether the build actually did fail a test case and, for example, how many test cases it failed. From the output of the defect prediction computerized model 104 and the label data, the test case generation subsystem 103 may generate an error for the defect prediction computerized model 104 in the epoch. The test case generation subsystem 103 may utilize any suitable training technique to modify the defect prediction computerized model 104 based on the error. An example training technique that may be used is gradient descent.

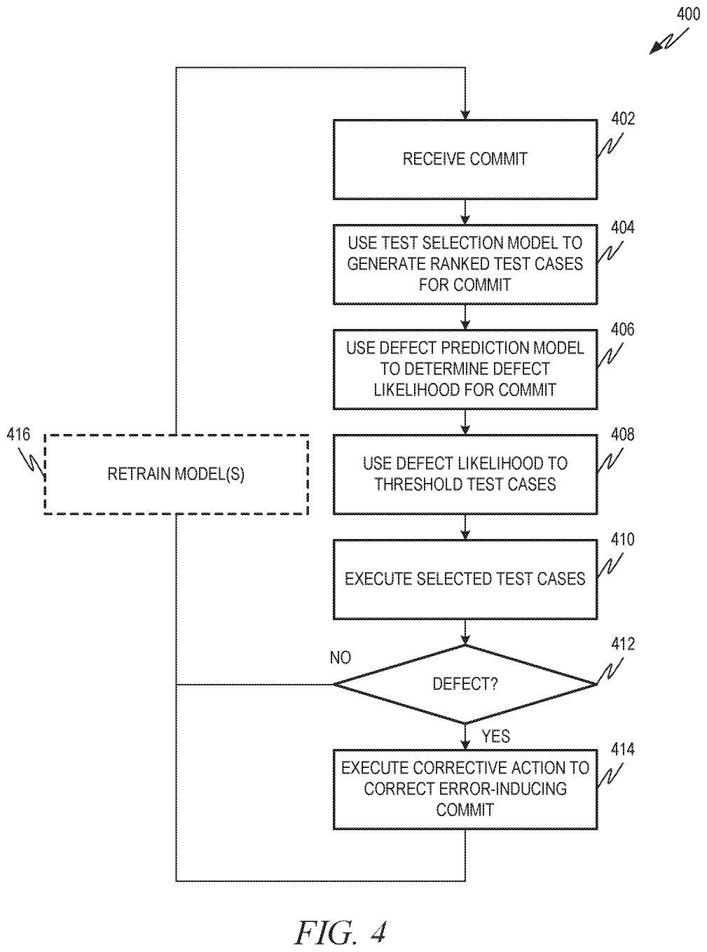

FIG. 4 is a flowchart showing one example of a process flow 400 that may be executed in the environment 100 to test a new build, such as the new build 120 of FIG. 1. In some examples, the process flow 400 is executed after the defect prediction computerized model 104 and the test selection computerized model 106 have been trained.

At operation 402, the test case generation subsystem 103 may receive an indication of a new build. The indication may include data describing the new build, data describing a commit operation associated with the new build, and/or the like. At operation 404, the test case generation subsystem 103 may execute the test selection computerized model to generate the preliminary ranked set of test cases 105. At operation 406, the test case generation subsystem 103 may execute the defect prediction computerized model 104 to determine a likelihood that the new build includes a defect. At operation 408, the test case generation subsystem 103 (e.g. the test case threshold subsystem 112) may use the defect likelihood generated by the defect prediction computerized model 104 to generate and apply a threshold to the preliminary ranked set of test cases 105, resulting in the ranked set of test cases 107.

At operation 410, the test case execution subsystem 108 may execute test cases from the ranked set of test cases 107 against the new build. The test case execution subsystem 108 may continue executing test cases until all test cases of the ranked set of test cases 107 have been executed against the new build or until the new build fails a test case. At operation 412, the testing system 102 determines if the new build included defects. The new build may include a defect if it has failed at least one of the ranked set of test cases 107. If the new build includes a defect, the corrective action subsystem 110 may, at operation 414, implement a corrective action, for example, as described herein.

If the new build did not include any defects (passed all of the ranked set of test cases 107), then the testing system 102 may return to operation 402 upon receiving a next commit operation. Optionally, the test case generation subsystem 103 may, at optional operation 416, retrain the defect prediction computerized model 104 and/or the test selection computerized model 106. For example, the computerized models 104, 106 may be retrained using additional training data generated from execution of the plurality of test cases against various new builds. The defect prediction computerized model 104 and test selection computerized model 106 may be retrained in a manner similar to the training described herein.

In view of the disclosure above, various examples are set forth below. It should be noted that one or more features of an example, taken in isolation or combination, should be considered within the disclosure of this application.

### Examples

Example 1 is a system for maintaining a software application, comprising: at least one processor programmed to perform operations comprising: receiving an indication of a commit operation executed on the software application to generate a build of the software application; accessing test case data describing a plurality of test cases that may be executed to identify software errors; executing a test selection computerized model, an output of the test selection computerized model being based at least in part on the commit operation and the plurality of test cases; executing a defect prediction computerized model, an output of the defect prediction computerized model being based at least in part on the commit operation; generating a ranked set of test cases selected from the plurality of test cases, the ranked set of test cases comprising less than all of the plurality of test cases; executing at least a portion of the ranked set of test cases against the build of the software application; and responsive to determining that the build of the software application failed at least one of the ranked set of test cases, executing a corrective action.

In Example 2, the subject matter of Example 1 optionally includes the output of the test selection computerized model comprising a preliminary ranked set of test cases selected from the plurality of test cases, the generating of the ranked set of test cases comprising selecting a subset of the preliminary ranked set of test cases based on the output of the defect prediction computerized model.

In Example 3, the subject matter of any one or more of Examples 1-2 optionally includes the executing of the ranked set of test cases comprising executing the ranked set of test cases in an order indicated by a ranking of the ranked set of test cases.

In Example 4, the subject matter of any one or more of Examples 1-3 optionally includes an input to the test selection computerized model comprising historical feature data corresponding to a first test case of the plurality of test cases, the historical feature data comprising a past failure rate of the first test case and an execution time of the first test case.

In Example 5, the subject matter of any one or more of Examples 1˜4 optionally includes an input to the test selection computerized model comprising lexical feature data describing a name of a first test case of the plurality of test cases.

In Example 6, the subject matter of any one or more of Examples 1-5 optionally includes an input to the test selection computerized model comprising coverage data describing a number of modified code elements of the build the software application are covered by a first test case of the plurality of test cases.

In Example 7, the subject matter of any one or more of Examples 1-6 optionally includes an input to the defect prediction computerized model comprising diffusion data describing a distribution of changes introduced by the commit operation to the build of the software application.

In Example 8, the subject matter of any one or more of Examples 1-7 optionally includes an input to the defect prediction computerized model comprising size data describing a size of a change introduced by the commit operation to the build of the software application.

In Example 9, the subject matter of any one or more of Examples 1-8 optionally includes an input to the defect prediction computerized model comprising purpose data describing a purpose of at least one change introduced by the commit operation to the build of the software application.

In Example 10, the subject matter of any one or more of Examples 1-9 optionally includes an input to the defect prediction computerized model comprising history data describing previous changes to the software application.

In Example 11, the subject matter of any one or more of Examples 1-10 optionally includes an input to the defect prediction computerized model comprising indentation data describing a number of indentations introduced to the software application by the commit operation.

In Example 12, the subject matter of any one or more of Examples 1-11 optionally includes the corrective action comprising sending a report message to a developer user, the report message comprising an indication of the commit operation.

In Example 13, the subject matter of any one or more of Examples 1-12 optionally includes the corrective action comprising accessing a good build of the software application generated by a good commit operation prior to the commit operation.

Example 14 is a method for maintaining a software application, comprising: receiving, by at least one processor, an indication of a commit operation executed on the software application to generate a build of the software application; accessing, by the at least one processor, test case data describing a plurality of test cases that may be executed to identify software errors; executing, by the at least one processor, a test selection computerized model, an output of the test selection computerized model being based at least in part on the commit operation and the plurality of test cases; executing, by the at least one processor, a defect prediction computerized model, an output of the defect prediction computerized model being based at least in part on the commit operation; generating, by the at least one processor, a ranked set of test cases selected from the plurality of test cases, the ranked set of test cases comprising less than all of the plurality of test cases; executing, by the at least one processor, at least a portion of the ranked set of test cases against the build of the software application; and responsive to determining that the build of the software application failed at least one of the ranked set of test cases, executing a corrective action.

In Example 15, the subject matter of Example 14 optionally includes the output of the test selection computerized model comprising a preliminary ranked set of test cases selected from the plurality of test cases, the generating of the ranked set of test cases comprising selecting a subset of the preliminary ranked set of test cases based on the output of the defect prediction computerized model.

In Example 16, the subject matter of any one or more of Examples 14-15 optionally includes the executing of the ranked set of test cases comprising executing the ranked set of test cases in an order indicated by a ranking of the ranked set of test cases.

In Example 17, the subject matter of any one or more of Examples 14-16 optionally includes an input to the test selection computerized model comprising historical feature data corresponding to a first test case of the plurality of test cases, the historical feature data comprising a past failure rate of the first test case and an execution time of the first test case.

In Example 18, the subject matter of any one or more of Examples 14-17 optionally includes an input to the test selection computerized model comprising lexical feature data describing a name of a first test case of the plurality of test cases.

In Example 19, the subject matter of any one or more of Examples 14-18 optionally includes an input to the test selection computerized model comprising coverage data describing a number of modified code elements of the build the software application are covered by a first test case of the plurality of test cases.

Example 20 is a non-transitory machine-readable medium comprising instructions thereon that, when executed by at least one processor, because the at least one processor to perform operations comprising: receiving an indication of a commit operation executed on a software application to generate a build of the software application; accessing test case data describing a plurality of test cases that may be executed to identify software errors; executing a test selection computerized model, an output of the test selection computerized model being based at least in part on the commit operation and the plurality of test cases; executing a defect prediction computerized model, an output of the defect prediction computerized model being based at least in part on the commit operation; generating a ranked set of test cases selected from the plurality of test cases, the ranked set of test cases comprising less than all of the plurality of test cases; executing at least a portion of the ranked set of test cases against the build of the software application; and responsive to determining that the build of the software application failed at least one of the ranked set of test cases, executing a corrective action.

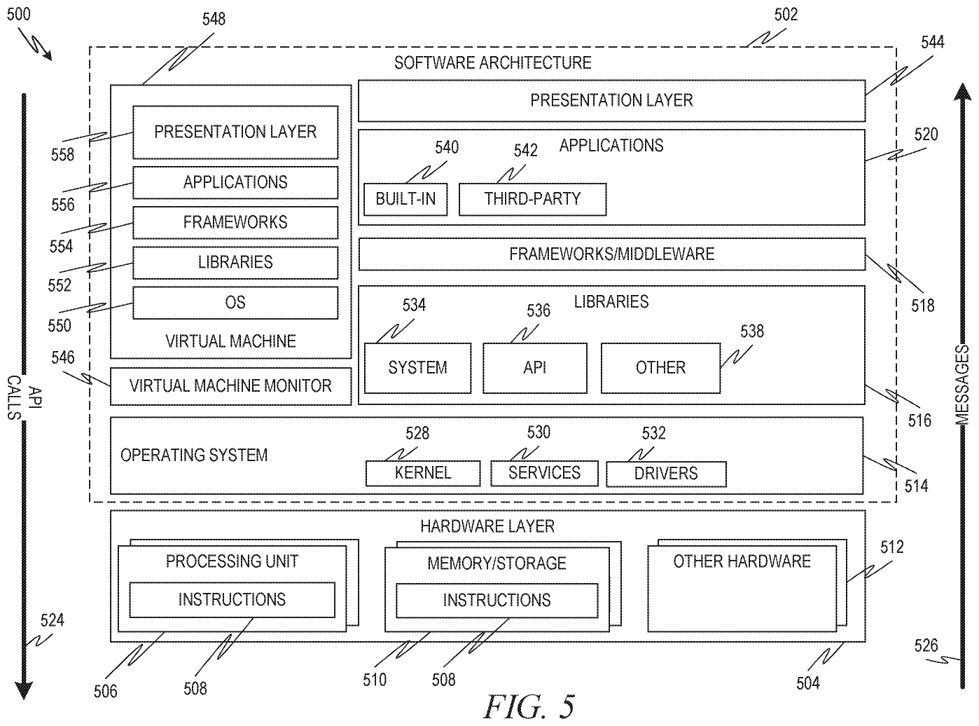

FIG. 5 is a block diagram 500 showing one example of a software architecture 502 for a computing device. The software architecture 502 may be used in conjunction with various hardware architectures, for example, as described herein. FIG. 5 is merely a non-limiting example of a software architecture and many other architectures may be implemented to facilitate the functionality described herein. The software architecture 502 and various other components described in FIG. 5 may be used to implement various other systems described herein. For example, the software architecture 502 shows one example way for implementing a testing system 102 or other computing devices described herein.

In FIG. 5, a representative hardware layer 504 is illustrated and can represent, for example, any of the above referenced computing devices. In some examples, the hardware layer 504 may be implemented according to the architecture of the computer system of FIG. 5.

The representative hardware layer 504 comprises one or more processing units 506 having associated executable instructions 508. Executable instructions 508 represent the executable instructions of the software architecture 502, including implementation of the methods, modules, subsystems, and components, and so forth described herein and may also include memory and/or storage modules 510, which also have executable instructions 508. Hardware layer 504 may also comprise other hardware as indicated by other hardware 512 which represents any other hardware of the hardware layer 504, such as the other hardware illustrated as part of the software architecture 502.

In the example architecture of FIG. 5, the software architecture 502 may be conceptualized as a stack of layers where each layer provides particular functionality. For example, the software architecture 502 may include layers such as an operating system 514, libraries 516, middleware layer 518 (sometimes referred to as frameworks), applications 520, and presentation layer 544. Operationally, the applications 520 and/or other components within the layers may invoke API calls 524 through the software stack and access a response, returned values, and so forth illustrated as messages 526 in response to the API calls 524. The layers illustrated are representative in nature and not all software architectures have all layers. For example, some mobile or special purpose operating systems may not provide the middleware layer 518, while others may provide such a layer. Other software architectures may include additional or different layers.

The operating system 514 may manage hardware resources and provide common services. The operating system 514 may include, for example, a kernel 528, services 530, and drivers 532. The kernel 528 may act as an abstraction layer between the hardware and the other software layers. For example, the kernel 528 may be responsible for memory management, processor management (e.g., scheduling), component management, networking, security settings, and so on. The services 530 may provide other common services for the other software layers. In some examples, the services 530 include an interrupt service. The interrupt service may detect the receipt of an interrupt and, in response, cause the software architecture 502 to pause its current processing and execute an interrupt service routine (ISR) when an interrupt is accessed.

The drivers 532 may be responsible for controlling or interfacing with the underlying hardware. For instance, the drivers 532 may include display drivers, camera drivers, Bluetooth® drivers, flash memory drivers, serial communication drivers (e.g., Universal Serial Bus (USB) drivers), Wi-Fi® drivers, NFC drivers, audio drivers, power management drivers, and so forth depending on the hardware configuration.

The libraries 516 may provide a common infrastructure that may be utilized by the applications 520 and/or other components and/or layers. The libraries 516 typically provide functionality that allows other software modules to perform tasks in an easier fashion than to interface directly with the underlying operating system 514 functionality (e.g., kernel 528, services 530 and/or drivers 532). The libraries 516 may include system 534 libraries (e.g., C standard library) that may provide functions such as memory allocation functions, string manipulation functions, mathematic functions, and/or the like. In addition, the libraries 516 may include API libraries 536 such as media libraries (e.g., libraries to support presentation and manipulation of various media format such as MPEG4, H.264, MP3, AAC, AMR, JPG, PNG), graphics libraries (e.g., an OpenGL framework that may be used to render 2D and 3D in a graphic content on a display), database libraries (e.g., SQLite that may provide various relational database functions), web libraries (e.g., WebKit that may provide web browsing functionality), and/or the like. The libraries 516 may also include a wide variety of other libraries 538 to provide many other APIs to the applications 520 and other software components/modules.

The middleware layer 518 (also sometimes referred to as frameworks) may provide a higher-level common infrastructure that may be utilized by the applications 520 and/or other software components/modules. For example, the middleware layer 518 may provide various graphic user interface (GUI) functions, high-level resource management, high-level location services, and so forth. The middleware layer 518 may provide a broad spectrum of other APIs that may be utilized by the applications 520 and/or other software components/modules, some of which may be specific to a particular operating system or platform.

The applications 520 include built-in applications 540 and/or third-party applications 542. Examples of representative built-in applications 540 may include, but are not limited to, a contacts application, a browser application, a book reader application, a location application, a media application, a messaging application, and/or a game application. Third-party applications 542 may include any of the built-in applications 540 as well as a broad assortment of other applications. In a specific example, the third-party application 542 (e.g., an application developed using the Android™ or iOS™ software development kit (SDK) by an entity other than the vendor of the particular platform) may be mobile software running on a mobile operating system such as iOS™ Android™, Windows® Phone, or other mobile computing device operating systems. In this example, the third-party application 542 may invoke the API calls 524 provided by the mobile operating system, such as operating system 514, to facilitate functionality described herein.

The applications 520 may utilize built-in operating system functions (e.g., kernel 528, services 530 and/or drivers 532), libraries (e.g., system 534, API libraries 536, and other libraries 538), and middleware layer 518 to create user interfaces to interact with users of the system. Alternatively, or additionally, in some systems interactions with a user may occur through a presentation layer, such as presentation layer 544. In these systems, the application/module “logic” can be separated from the aspects of the application/module that interact with a user.

Some software architectures utilize virtual machines. For example, the various environments described herein may implement one or more virtual machines executing to provide a software application or service. The example of FIG. 5 illustrates by virtual machine 548. A virtual machine creates a software environment where applications/modules can execute as if they were executing on a hardware computing device. A virtual machine 548 is hosted by a host operating system (operating system 514) and typically, although not always, has a virtual machine monitor 546, which manages the operation of the virtual machine 548 as well as the interface with the host operating system (i.e., operating system 514). A software architecture executes within the virtual machine 548. The software architecture may be or include, for example, an operating system 550, libraries 552, frameworks/middleware 554, applications 556 and/or presentation layer 558. These layers of software architecture executing within the virtual machine 548 can be the same as corresponding layers previously described or may be different.

Certain embodiments are described herein as including logic or a number of components, modules, or mechanisms. Modules may constitute cither software modules (e.g., code embodied (1) on a non-transitory machine-readable medium or (2) in a transmission signal) or hardware-implemented modules. A hardware-implemented module is a tangible unit capable of performing certain operations and may be configured or arranged in a certain manner. In example embodiments, one or more computer systems (e.g., a standalone, client, or server computer system) or one or more hardware processors may be configured by software (e.g., an application or application portion) as a hardware-implemented module that operates to perform certain operations as described herein.

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment, or a server farm), while in other embodiments the processors may be distributed across a number of locations.

Example embodiments may be implemented in digital electronic circuitry, or in computer hardware, firmware, or software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

Computer software, including code for implementing software services, can be written in any form of programming language, including compiled or interpreted languages, and it can be deployed in any form, including as a standalone program or as a module, subroutine, or other unit suitable for use in a computing environment. Computer software can be deployed to be executed on one computer or on multiple computers at one site or distributed across multiple sites and interconnected by a communication network.

In example embodiments, operations may be performed by one or more programmable processors executing a computer program to perform functions by operating on input data and generating output.

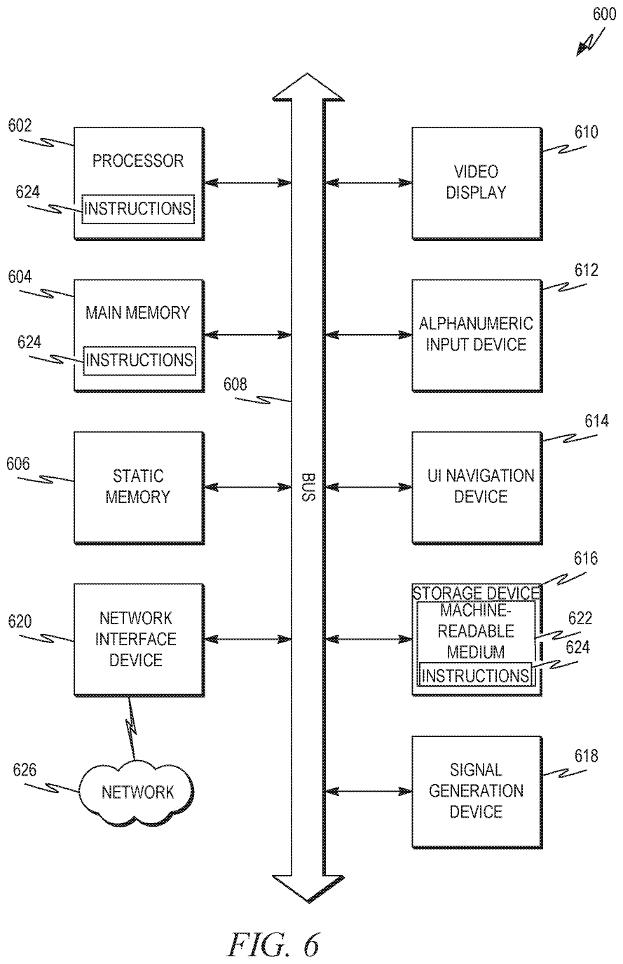

FIG. 6 is a block diagram of a machine in the example form of a computer system 600 within which instructions 624 may be executed for causing the machine to perform any one or more of the methodologies discussed herein. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a personal digital assistant (PDA), a cellular telephone, a web appliance, a network router, switch, or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 600 includes a processor 602 (e.g., a central processing unit (CPU), a graphics processing unit (GPU), or both), a main memory 604, and a static memory 606, which communicate with each other via a bus 608. The computer system 600 may further include a video display unit 610 (e.g., a liquid crystal display (LCD) or a cathode ray tube (CRT)). The computer system 600 also includes an alphanumeric input device 612 (e.g., a keyboard or a touch-sensitive display screen), a user interface (UI) navigation (or cursor control) device 614 (e.g., a mouse), a storage device 616, such as a disk drive unit, a signal generation device 618 (e.g., a speaker), and a network interface device 620.

The disk drive unit 616 includes a machine-readable medium 622 on which is stored one or more sets of data structures and instructions 624 (e.g., software) embodying or utilized by any one or more of the methodologies or functions described herein. The instructions 624 may also reside, completely or at least partially, within the main memory 604 and/or within the processor 602 during execution thereof by the computer system 600, with the main memory 604 and the processor 602 also constituting machine-readable media 622.

While the machine-readable medium 622 is shown in an example embodiment to be a single medium, the term “machine-readable medium” may include a single medium or multiple media (e.g., a centralized or distributed database, and/or associated caches and servers) that store the one or more instructions 624 or data structures. The term “machine-readable medium” shall also be taken to include any tangible medium that is capable of storing, encoding, or carrying instructions 624 for execution by the machine and that cause the machine to perform any one or more of the methodologies of the present disclosure, or that is capable of storing, encoding, or carrying data structures utilized by or associated with such instructions 624. The term “machine-readable medium” shall accordingly be taken to include, but not be limited to, solid-state memories, and optical and magnetic media. Specific examples of machine-readable media 622 include non-volatile memory, including by way of example semiconductor memory devices, e.g., erasable programmable read-only memory (EPROM), electrically erasable programmable read-only memory (EEPROM), and flash memory devices; magnetic disks such as internal hard disks and removable disks; magneto-optical disks; and CD-ROM and DVD-ROM disks.

The instructions 624 may further be transmitted or received over a communications network 626 using a transmission medium. The instructions 624 may be transmitted using the network interface device 620 and any one of a number of well-known transfer protocols (e.g., HTTP). Examples of communication networks include a local area network (LAN), a wide area network (WAN), the Internet, mobile telephone networks, plain old telephone (POTS) networks, and wireless data networks (e.g., Wi-Fi and WiMax networks). The term “transmission medium” shall be taken to include any intangible medium that is capable of storing, encoding, or carrying instructions 624 for execution by the machine, and includes digital or analog communications signals or other intangible media to facilitate communication of such software.

Although an embodiment has been described with reference to specific example embodiments, it will be evident that various modifications and changes may be made to these embodiments without departing from the broader spirit and scope of the disclosure. Accordingly, the specification and drawings are to be regarded in an illustrative rather than a restrictive sense. The accompanying drawings that form a part hereof show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

What is claimed is:

1. A system for maintaining a software application, comprising:
at least one processor programmed to perform operations comprising:
receiving an indication of a commit operation executed on the software application to generate a build of the software application;
accessing test case data describing a plurality of test cases that may be executed to identify software errors;
executing a test selection computerized model, an output of the test selection computerized model being based at least in part on the commit operation and the plurality of test cases;
executing a defect prediction computerized model, an output of the defect prediction computerized model being based at least in part on the commit operation;
generating a ranked set of test cases selected from the plurality of test cases, the ranked set of test cases comprising less than all of the plurality of test cases;
executing at least a portion of the ranked set of test cases against the build of the software application; and
responsive to determining that the build of the software application failed at least one of the ranked set of test cases, executing a corrective action.

2. The system of claim 1, the output of the test selection computerized model comprising a preliminary ranked set of test cases selected from the plurality of test cases, the generating of the ranked set of test cases comprising selecting a subset of the preliminary ranked set of test cases based on the output of the defect prediction computerized model.

3. The system of claim 1, the executing of the ranked set of test cases comprising executing the ranked set of test cases in an order indicated by a ranking of the ranked set of test cases.

4. The system of claim 1, an input to the test selection computerized model comprising historical feature data corresponding to a first test case of the plurality of test cases, the historical feature data comprising a past failure rate of the first test case and an execution time of the first test case.

5. The system of claim 1, an input to the test selection computerized model comprising lexical feature data describing a name of a first test case of the plurality of test cases.

6. The system of claim 1, an input to the test selection computerized model comprising coverage data describing a number of modified code elements of the build the software application are covered by a first test case of the plurality of test cases.

7. The system of claim 1, an input to the defect prediction computerized model comprising diffusion data describing a distribution of changes introduced by the commit operation to the build of the software application.

8. The system of claim 1, an input to the defect prediction computerized model comprising size data describing a size of a change introduced by the commit operation to the build of the software application.

9. The system of claim 1, an input to the defect prediction computerized model comprising purpose data describing a purpose of at least one change introduced by the commit operation to the build of the software application.

10. The system of claim 1, an input to the defect prediction computerized model comprising history data describing previous changes to the software application.

11. The system of claim 1, an input to the defect prediction computerized model comprising indentation data describing a number of indentations introduced to the software application by the commit operation.

12. The system of claim 1, the corrective action comprising sending a report message to a developer user, the report message comprising an indication of the commit operation.

13. The system of claim 1, the corrective action comprising accessing a good build of the software application generated by a good commit operation prior to the commit operation.

14. A method for maintaining a software application, comprising:
receiving, by at least one processor, an indication of a commit operation executed on the software application to generate a build of the software application;
accessing, by the at least one processor, test case data describing a plurality of test cases that may be executed to identify software errors;
executing, by the at least one processor, a test selection computerized model, an output of the test selection computerized model being based at least in part on the commit operation and the plurality of test cases;
executing, by the at least one processor, a defect prediction computerized model, an output of the defect prediction computerized model being based at least in part on the commit operation;
generating, by the at least one processor, a ranked set of test cases selected from the plurality of test cases, the ranked set of test cases comprising less than all of the plurality of test cases;
executing, by the at least one processor, at least a portion of the ranked set of test cases against the build of the software application; and
responsive to determining that the build of the software application failed at least one of the ranked set of test cases, executing a corrective action.

15. The method of claim 14, the output of the test selection computerized model comprising a preliminary ranked set of test cases selected from the plurality of test cases, the generating of the ranked set of test cases comprising selecting a subset of the preliminary ranked set of test cases based on the output of the defect prediction computerized model.

16. The method of claim 14, the executing of the ranked set of test cases comprising executing the ranked set of test cases in an order indicated by a ranking of the ranked set of test cases.

17. The method of claim 14, an input to the test selection computerized model comprising historical feature data corresponding to a first test case of the plurality of test cases, the historical feature data comprising a past failure rate of the first test case and an execution time of the first test case.

18. The method of claim 14, an input to the test selection computerized model comprising lexical feature data describing a name of a first test case of the plurality of test cases.

19. The method of claim 14, an input to the test selection computerized model comprising coverage data describing a number of modified code elements of the build the software application are covered by a first test case of the plurality of test cases.

20. A non-transitory machine-readable medium comprising instructions thereon that, when executed by at least one processor, because the at least one processor to perform operations comprising:
receiving an indication of a commit operation executed on a software application to generate a build of the software application;
accessing test case data describing a plurality of test cases that may be executed to identify software errors;
executing a test selection computerized model, an output of the test selection computerized model being based at least in part on the commit operation and the plurality of test cases;
executing a defect prediction computerized model, an output of the defect prediction computerized model being based at least in part on the commit operation;
generating a ranked set of test cases selected from the plurality of test cases, the ranked set of test cases comprising less than all of the plurality of test cases;
executing at least a portion of the ranked set of test cases against the build of the software application; and
responsive to determining that the build of the software application failed at least one of the ranked set of test cases, executing a corrective action.
